(19) United States
(12) Patent Application Publication
(10) Pub. No.: US 2026/0167198 A1
(43) Pub. Date: Jun. 18, 2026

(54) VEHICLE CONTROL DEVICE AND METHOD

(71) Applicants: Hyundai Motor Company, Seoul (KR); Kia Corporation, Seoul (KR)

(72) Inventors: Sung Hwan YUN, Hwaseong-Si (KR); Sung Woo CHOI, Hwaseong-Si (KR); Sung Jun PARK, Yongin-si (KR)

(21) Appl. No.: 19/285,412

(22) Filed: Jul. 30, 2025

(30) Foreign Application Priority Data
Dec. 12, 2024 (KR) 10-2024-0184633

(51) Int. Cl. B60W 30/18; B60W 30/095; B60W 30/12

(52) U.S. Cl. CPC B60W 30/18163; B60W 30/0956; B60W 30/12; B60W 2520/06; B60W 2520/10; B60W 2552/00; B60W 2554/4041; B60W 2554/4042; B60W 2554/80

(57) ABSTRACT

A vehicle control device is provided. The vehicle control device may identify, based on object recognition information received from a sensor of a host vehicle: target vehicle information describing a target vehicle within a threshold distance from the host vehicle; and a shape of a road that the host vehicle is traveling; generate, based on the target vehicle information and the shape of the road, a first route and a second route for the host vehicle; determine, based on the target vehicle information, a probability score of a successful lane change of the host vehicle; generate, based on the probability score of the successful lane change, a vehicle control signal for controlling an operation of the host vehicle for each of the first route and the second route; and control, based on the vehicle control signal, the operation of the host vehicle.

### CROSS-REFERENCE TO RELATED APPLICATION

This application claims priority to Korean Patent Application No. 10-2024-0184633, filed on Dec. 12, 2024, the disclosure of which is incorporated herein by reference in its entirety.

### FIELD

The present disclosure relates to a vehicle control device and method.

### BACKGROUND

Autonomous vehicles may perform lane keeping or lane changing depending on the flow of traffic while traveling on a road. Lane changing is helpful not only in improving driving efficiency of a vehicle but also in ensuring safe driving in emergency situations (e.g., avoiding obstacles, overtaking slow vehicles, and the like). However, when changing lanes, a number of problems may occur, which, if not resolved, may negatively affect the safety, efficiency, and comfort of driving a vehicle.

### SUMMARY

The present disclosure is directed to providing a vehicle control device and method capable of establishing a vehicle driving strategy safely and efficiently.

The present disclosure is also directed to providing a vehicle control device and method capable of detecting a dangerous situation in real time and establishing a driving strategy using a safe route among multiple routes.

The present disclosure is also directed to providing a vehicle control device and method capable of establishing a driving strategy that reflects a lane change possibility and stability according to an actual driving pattern.

According to one or more example embodiments of the present disclosure, a vehicle control device for a host vehicle may include: a plurality of processors including a first processor, a second processor, a third processor, and a fourth processor; and a memory storing at least one instruction. The at least one instruction may be configured, when executed by the first processor communicating with the memory, to cause the vehicle control device to: identify, based on object recognition information received from a sensor of the host vehicle: target vehicle information describing a target vehicle within a threshold distance from the host vehicle; and a shape of a road that the host vehicle is traveling on. The at least one instruction may be configured, when executed by the second processor communicating with the memory, to further cause the vehicle control device to: generate, based on the target vehicle information and the shape of the road, a first route and a second route for the host vehicle. The at least one instruction may be configured, when executed by the third processor communicating with the memory, to further cause the vehicle control device to: determine, based on the target vehicle information, a probability score of a successful lane change of the host vehicle. The at least one instruction may be configured, when executed by the fourth processor communicating with the memory, to further cause the vehicle control device to: generate, based on the probability score of the successful lane change, a vehicle control signal for controlling an operation of the host vehicle for each of the first route and the second route; and control, based on the vehicle control signal, the operation of the host vehicle.

The first route may be associated with staying on a current driving lane of the host vehicle and the second route is associated with a lane change.

The at least one instruction may be configured, when executed by the second processor communicating with the memory, to cause the vehicle control device to generate the first route and the second route by: generating a potential field by: determining, based on a driving direction of the host vehicle based on the shape of the road, a first potential of the potential field; and determining, based on a location of the target vehicle, a second potential of the potential field.

The at least one instruction may be configured, when executed by the second processor communicating with the memory, to cause the vehicle control device to generate the first route and the second route by: generating the first route and the second route based on a sum potential of the first potential and the second potential in the potential field.

The at least one instruction may be configured, when executed by the third processor communicating with the memory, to cause the vehicle control device to determine the probability score of the successful lane change by: determining the probability score of the successful lane change further based on a location of the host vehicle, a speed of the host vehicle, a location of the target vehicle, and a speed of the target vehicle.

The target vehicle may be a first target vehicle. The at least one instruction may be configured, when executed by the third processor communicating with the memory, to cause the vehicle control device to determine the probability score of the successful lane change by: based on the location of the host vehicle, the speed of the host vehicle, the location of the target vehicle, and the speed of the target vehicle, determining: a probability score of a second target vehicle decelerating; and a probability score of a collision-free lane change of the first target vehicle; and determining the probability score of the successful lane change of the host vehicle further based on the probability score of the second target vehicle decelerating and the probability score of the collision-free lane change of the first target vehicle. The second target vehicle may be traveling in an adjacent driving lane of the target vehicle.

The at least one instruction may be configured, when executed by the third processor communicating with the memory, to cause the vehicle control device to determine the probability score, of the second target vehicle decelerating, by: determining, based on an expected time to collision between the host vehicle and the first target vehicle, the probability score of the second target vehicle decelerating.

The at least one instruction may be configured, when executed by the third processor communicating with the memory, to cause the vehicle control device to determine the probability score of the collision-free lane change of the first target vehicle by: determining, based on a relative distance between the host vehicle and the first target vehicle, the probability score of the collision-free lane change of the first target vehicle.

The at least one instruction may be configured, when executed by the fourth processor communicating with the memory, to cause the vehicle control device to generate the vehicle control signal by: using the probability score of the successful lane change as a weight.

The at least one instruction may be configured, when executed by the fourth processor communicating with the memory, to cause the vehicle control device to generate the vehicle control signal by: applying the probability score of the successful lane change as the weight to each control point of the first route and the second route.

According to one or more example embodiments of the present disclosure, a method performed by an apparatus of a host vehicle may include: identifying, by one or more processors based on object recognition information received from a sensor of the host vehicle: target vehicle information describing a target vehicle within a threshold distance from the host vehicle, and a shape of a road that the host vehicle is traveling on; generating, by the one or more processors based on the target vehicle information and the shape of the road, a first route and a second route for the host vehicle; determining, by the one or more processors based on the target vehicle information, a probability score of a successful lane change of the host vehicle; generating, by the one or more processors based on the probability score of the successful lane change, a vehicle control signal for controlling an operation of the host vehicle for each of the first route and the second route; and controlling, based on the vehicle control signal, the operation of the host vehicle.

The first route may be associated with staying on a current driving lane of the host vehicle and the second route is associated with a lane change.

Generating the first route and the second route may include: generating a potential field by: determining, based on a driving direction of the host vehicle based on the shape of the road, a first potential of the potential field; and determining, based on a location of the target vehicle, a second potential of the potential field.

Generating the first route and the second route may include: generating the first route and the second route based on a sum potential of the first potential and the second potential in the potential field.

Determining the probability score of the successful lane change may include: determining the probability score of the successful lane change further based on a location of the host vehicle, a speed of the host vehicle, a location of the target vehicle, and a speed of the target vehicle.

The target vehicle may be a first target vehicle. Determining the probability score of the successful lane change may include: based on the location of the host vehicle, the speed of the host vehicle, the location of the target vehicle, and the speed of the target vehicle, determining: a probability score of a second target vehicle decelerating; and a probability score of a collision-free lane change of the first target vehicle; and determining the probability score of the successful lane change of the host vehicle further based on the probability score of the second target vehicle decelerating and the probability score of the collision-free lane change of the first target vehicle. The second target vehicle may be traveling in an adjacent driving lane of the target vehicle.

Determining the probability score of the second target vehicle decelerating may include: determining, based on an expected time to collision between the host vehicle and the first target vehicle, the probability score of the second target vehicle decelerating.

Determining the probability score of the collision-free lane change of the first target vehicle may include: determining, based on a relative distance between the host vehicle and the first target vehicle, the probability score of the collision-free lane change of the first target vehicle.

Generating the vehicle control signal may include: using the probability score of the successful lane change as a weight.

Generating the vehicle control signal may include: applying the probability score of the successful lane change as the weight to each control point of the first route and the second route.

### BRIEF DESCRIPTION OF THE DRAWINGS

The above and other objects, features and advantages of the present disclosure will become more apparent to those of ordinary skill in the art by describing one or more example embodiments thereof in detail with reference to the accompanying drawings, in which:

FIG. 1 is a view showing a vehicle transmitting and receiving data by communicating with other devices;

FIG. 2 is a diagram showing modules constituting a vehicle;

FIG. 3 is a diagram for describing the operation of a vehicle control device;

FIG. 4 is a view for describing the operation of a second processing unit;

FIG. 5 is a view for describing the operation of a third processing unit;

FIG. 6 is a view for describing the operation of a fourth processing unit;

FIGS. 7, 8, 9, and 10 are operation concept views of a vehicle control device; and

FIG. 11 is a flowchart of a method of controlling a vehicle.

### DETAILED DESCRIPTION

Hereinafter, one or more example embodiments of the present disclosure will be described in detail with reference to the accompanying drawings.

However, the technical idea of the present disclosure is not limited to the example embodiments to be described but may be implemented in various different forms, and within the scope of the technical idea of the present disclosure, one or more among components in the example embodiments may be used by being selectively combined and substituted.

Further, unless specifically defined and described, terms used in the example embodiments of the present disclosure (including technical and scientific terms) may be interpreted as meanings which are generally understood by those skilled in the art to which the present disclosure pertains, and commonly used terms such as terms defined in dictionaries may be interpreted in consideration of the contextual meaning of the related art.

The terms used in the example embodiments of the present disclosure are for the purpose of describing the example embodiments only and are not intended to limit the disclosure.

In the present specification, the singular forms may include the plural forms unless the context clearly dictates otherwise. For purposes of this application and the claims, using the exemplary phrase “at least one of: A; B; or C” or “at least one of A, B, or C,” the phrase means “at least one A, or at least one B, or at least one C, or any combination of at least one A, at least one B, and at least one C. Further, exemplary phrases, such as “A, B, or C”, “at least one of A, B, and C”, “at least one of A, B, or C”, etc. as used herein may mean each listed item or all possible combinations of the listed items. For example, “at least one of A or B” may refer to (1) at least one A; (2) at least one B; or (3) at least one A and at least one B.

In addition, when describing components of example embodiments of the present disclosure, terms such as first, second, A, B, (a), (b), etc., may be used.

These terms are only for distinguishing the components from other components, and the essence, sequence, or order of the components is not limited by these terms.

In addition, when a component is described as being “linked,” “coupled,” or “connected” to another component, the component is not only directly linked, coupled, or connected to another component, but also “linked,” “coupled,” or “connected” to another component with still another component disposed between the component and the other component.

Further, when a component is described as being formed or disposed “on (above) or under (below)” another component, the term “on (above) or under (below)” includes not only when two components are in direct contact with each other, but also when one or more other components are formed or disposed between the two components. Further, when a component is described as being “on (above) or below (under),” the description may include the meanings of an upward direction and a downward direction based on one component.

An automation level of an autonomous driving vehicle may be classified as follows, according to the American Society of Automotive Engineers (SAE). At autonomous driving level 0, the SAE classification standard may correspond to “no automation,” in which an autonomous driving system is temporarily involved in emergency situations (e.g., automatic emergency braking) and/or provides warnings only (e.g., blind spot warning, lane departure warning, etc.), and a driver is expected to operate the vehicle. At autonomous driving level 1, the SAE classification standard may correspond to “driver assistance,” in which the system performs some driving functions (e.g., steering, acceleration, brake, lane centering, adaptive cruise control, etc.) while the driver operates the vehicle in a normal operation section, and the driver is expected to determine an operation state and/or timing of the system, perform other driving functions, and cope with (e.g., resolve) emergency situations. At autonomous driving level 2, the SAE classification standard may correspond to “partial automation,” in which the system performs steering, acceleration, and/or braking under the supervision of the driver, and the driver is expected to determine an operation state and/or timing of the system, perform other driving functions, and cope with (e.g., resolve) emergency situations. At autonomous driving level 3, the SAE classification standard may correspond to “conditional automation,” in which the system drives the vehicle (e.g., performs driving functions such as steering, acceleration, and/or braking) under limited conditions but transfer driving control to the driver when the required conditions are not met, and the driver is expected to determine an operation state and/or timing of the system, and take over control in emergency situations but do not otherwise operate the vehicle (e.g., steer, accelerate, and/or brake). At autonomous driving level 4, the SAE classification standard may correspond to “high automation,” in which the system performs all driving functions, and the driver is expected to take control of the vehicle only in emergency situations. At autonomous driving level 5, the SAE classification standard may correspond to “full automation,” in which the system performs full driving functions without any aid from the driver including in emergency situations, and the driver is not expected to perform any driving functions other than determining the operating state of the system. Although the present disclosure may apply the SAE classification standard for autonomous driving classification, other classification methods and/or algorithms may be used in one or more configurations described herein. One or more features associated with autonomous driving control may be activated based on configured autonomous driving control setting(s) (e.g., based on at least one of: an autonomous driving classification, a selection of an autonomous driving level for a vehicle, etc.).

Based on one or more features (e.g., analyzing a lane change possibility based on multiple routes, etc.) described herein, an operation of the vehicle may be controlled. The vehicle control may include various operational controls associated with the vehicle (e.g., autonomous driving control, sensor control, braking control, braking time control, acceleration control, acceleration change rate control, alarm timing control, forward collision warning time control, etc.).

One or more auxiliary devices (e.g., engine brake, exhaust brake, hydraulic retarder, electric retarder, regenerative brake, etc.) may also be controlled, for example, based on one or more features (e.g., analyzing a lane change possibility based on multiple routes, etc.) described herein. One or more communication devices (e.g., a modem, a network adapter, a radio transceiver, an antenna, etc., that is capable of communicating via one or more wired or wireless communication protocols, such as Ethernet, Wi-Fi, near-field communication (NFC), Bluetooth, Long-Term Evolution (LTE), 5G New Radio (NR), vehicle-to-everything (V2X), etc.) may also be controlled, for example, based on one or more features (e.g., analyzing a lane change possibility based on multiple routes, etc.) described herein.

Minimum risk maneuver (MRM) operation(s) may also be controlled, for example, based on one or more features (e.g., analyzing a lane change possibility based on multiple routes, etc.) described herein. A minimal risk maneuvering operation (e.g., a minimal risk maneuver, a minimum risk maneuver) may be a maneuvering operation of a vehicle to minimize (e.g., reduce) a risk of collision with surrounding vehicles in order to reach a lowered (e.g., minimum) risk state. A minimal risk maneuver may be an operation that may be activated during autonomous driving of the vehicle when a driver is unable to respond to a request to intervene. During the minimal risk maneuver, one or more processors of the vehicle may control a driving operation of the vehicle for a set period of time.

Biased driving operation(s) may also be controlled, for example, based on one or more features (e.g., analyzing a lane change possibility based on multiple routes, etc.) described herein. A driving control apparatus may perform a biased driving control. To perform a biased driving, the driving control apparatus may control the vehicle to drive in a lane by maintaining a lateral distance between the position of the center of the vehicle and the center of the lane. For example, the driving control apparatus may control the vehicle to stay in the lane but not in the center of the lane.

An autonomous driving level and/or autonomous driving activation/deactivation may also be controlled, for example, based on one or more features (e.g., analyzing a lane change possibility based on multiple routes, etc.) described herein. A driving control apparatus may perform an autonomous driving level control (e.g., a change of an autonomous driving level, a change of a required user attentiveness, etc.) or cause deactivation of an autonomous driving operation. For example, by changing the required user attentiveness, the driver may be required to place his/her hands on the driving wheel more often (e.g., at least once in a threshold time period, such as five second, 30 seconds, 1 minute, etc.). By changing the required user attentiveness, the driver may be required to look ahead more often (e.g., at least once in a threshold time period, such as five second, 30 seconds, 1 minute, etc.). By changing the autonomous driving level, one or more video contents may not be displayed on a display of the vehicle.

The driving control apparatus may identify a biased target lateral distance for biased driving control. For example, a biased target lateral distance may comprise an intentionally adjusted lateral distance that a vehicle may aim to maintain from a reference point, such as the center of a lane or another vehicle, during maneuvers such as lane changes. This adjustment may be made to improve the vehicle's stability, safety, and/or performance under varying driving conditions, etc. For example, during a lane change, the driving control system may bias the lateral distance to keep a safer gap from adjacent vehicles, considering factors such as the vehicle's speed, road conditions, and/or the presence of obstacles, etc.

One or more sensors (e.g., IMU sensors, camera, LIDAR, RADAR, blind spot monitoring sensor, line departure warning sensor, parking sensor, light sensor, rain sensor, traction control sensor, anti-lock braking system sensor, tire pressure monitoring sensor, seatbelt sensor, airbag sensor, fuel sensor, emission sensor, throttle position sensor, inverter, converter, motor controller, power distribution unit, high-voltage wiring and connectors, auxiliary power modules, charging interface, etc.) may also be controlled, for example, based on one or more features (e.g., analyzing a lane change possibility based on multiple routes, etc.) described herein.

An operation control for autonomous driving of the vehicle may include various driving control of the vehicle by the vehicle control device (e.g., acceleration, deceleration, steering control, gear shifting control, braking system control, traction control, stability control, cruise control, lane keeping assist control, collision avoidance system control, emergency brake assistance control, traffic sign recognition control, adaptive headlight control, etc.).

The vehicle that an autonomous driving system is actively controlling may be referred to as an ego vehicle, a host vehicle, or an autonomous vehicle. The ego vehicle may also be referred to as a self-driving car, an autonomous car (AC), a driverless car, a robotaxi, a robotic car, or a robo-car. The ego vehicle may be the vehicle that is equipped with the autonomous driving system. A car that is ahead of the ego vehicle (e.g., in the same driving lane as the ego vehicle) may be referred to as a vehicle in front, a lead vehicle, a leading vehicle, or a preceding vehicle. A car that follows the ego vehicle (e.g., in the same driving lane as the ego vehicle) may be referred to as a car behind, a trailing vehicle, or a succeeding vehicle. An adjacent vehicle may refer to any vehicle located in any direction (e.g., front, rear, left, right, diagonal, etc.) from the ego vehicle as long as no other vehicles (e.g., intervening vehicles) exist between it and the ego vehicle (e.g., regardless of the distance from the ego vehicle). Alternatively, in some contexts, only those vehicles that are located within a threshold distance (e.g., line of sight and/or detection limit of one or more sensors of the ego vehicle) from the ego vehicle may be referred to as adjacent vehicles. A target vehicle may be any vehicle that is near the ego vehicle (e.g., within a threshold distance away from the ego vehicle). The target vehicle may also be referred to as a nearby vehicle, a neighboring vehicle, a vehicle of interest, a surrounding vehicle, etc. The target vehicle may be any vehicle that the autonomous driving system monitors, recognizes, identifies, tracks, and/or analyzes, either actively or passively, either once or multiple times, and either sporadically or continuously. The threshold distance may be, for example, the line of sight and/or the detection limit of one or more sensors of the ego vehicle, but the threshold distance may be a value (e.g., an adjustable value) that is less than the line of sight and/or the detection limit of the one or more sensors of the ego vehicle. The target vehicle can be, for example, a vehicle in front, a vehicle behind, a vehicle in a different lane than the driving lane of the ego vehicle (e.g., a vehicle to the left, a vehicle to the right, a vehicle in a diagonal direction, etc.), and/or an adjacent vehicle (e.g., regardless of the distance from the ego vehicle and/or regardless of whether there are intervening vehicle(s) between the target vehicle and the ego vehicle). A target vehicle may also be referred to as a surrounding vehicle, a nearby vehicle, an external vehicle, another vehicle (other vehicles), and so forth.

Hereinafter, one or more example embodiments will be described in detail with reference to the accompanying drawings, but the same or corresponding components are denoted by the same reference numerals regardless of the drawing numbers, and redundant descriptions thereof will be omitted.

At least in some implementations, when attempting to change lanes, a vehicle in an adjacent lane may rapidly accelerate or decelerate, and such an unexpected vehicle behavior may negatively affect a route planning of an autonomous vehicle.

In addition, since the interaction with the vehicle on the adjacent lane (e.g., determining whether to yield) is uncertain, the autonomous vehicle may not attempt to change lanes or may hesitate.

Although lane change decision has to be made within a relatively short period of time, it may require enough time to analyze the movement of a nearby vehicle in real time and perform route planning and optimization. Thus, the lane change decision of the autonomous vehicle may be delayed, which may cause a driving route to become unstable or lane changes may be abandoned midway through.

In addition, attempting to change lanes with inaccurate timing may cause discomfort to occupants or reduce the quality of vehicle control due to rough steering.

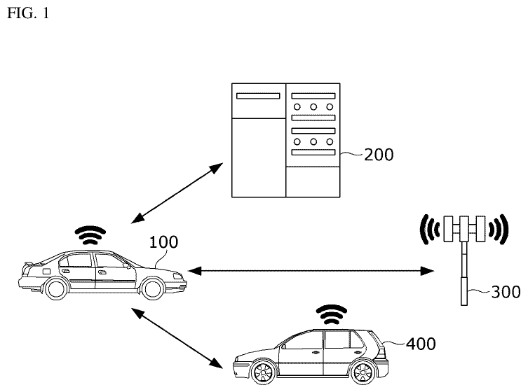

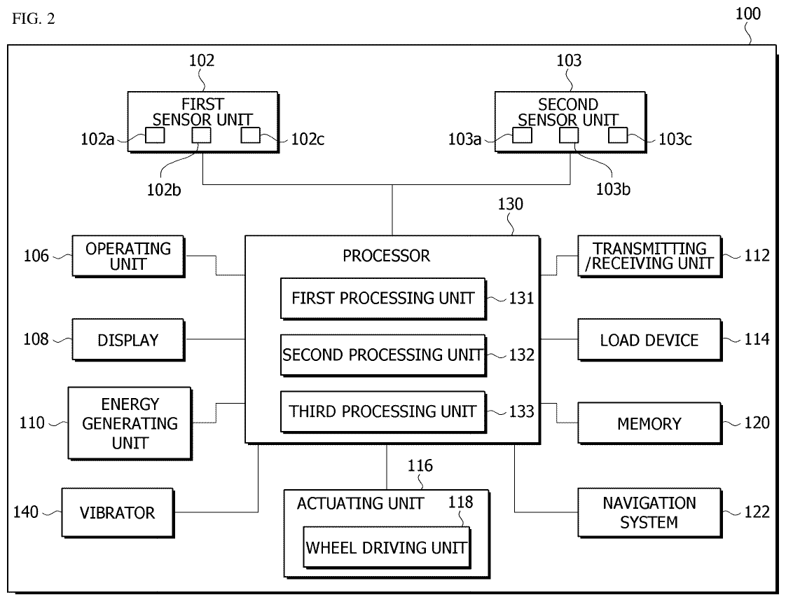

Hereinafter, a vehicle will be described with reference to FIGS. 1 and 2. FIG. 1 is a view illustrating a vehicle transmitting and receiving data by communicating with other devices.

Referring to FIG. 1, a vehicle 100 may be driven based on electrical energy or fossil energy. In the case of electrical energy, the vehicle 100 may be, for example, a pure battery-based vehicle driven only by a high-voltage battery, or may employ a gas-based fuel cell as an energy source. In addition, the fuel cell may use various types of gas capable of generating electrical energy, and the vehicle 100 may be filled with gas in a liquefied state, for example. Here, one example of the gas may be hydrogen. However, the gas is not limited thereto, and various gases may be applicable. In the case of fossil energy, the vehicle 100 is driven based on fuel such as gasoline, diesel or liquefied gas, and may be equipped with an internal combustion engine that drives an actuating unit (also referred to as an actuator) 116 by combustion of the fuel. The engine may be included in an energy generating unit (also referred to as a generator, a power generator, an energy generator, etc.) 110 in terms of providing a driving rotational force of wheels to a wheel driving unit (e.g., a powertrain) 118. As another example, the vehicle 100 may drive the actuating unit 116 by selectively utilizing energy from a fossil energy-based internal combustion engine and an electric battery, and may be a hybrid type vehicle.

The vehicle 100 may refer to a movable device. The vehicle 100 is a ground vehicle that travels on the ground and may be a typical passenger car, a commercial vehicle, a purpose-built vehicle (PBV), or the like. The vehicle 100 may be a four-wheeled vehicle, such as a passenger car, a sport utility vehicle (SUV), or a small truck, or may be a vehicle with more than four wheels, such as a bus, a large truck, a container transport vehicle, a heavy equipment vehicle, or the like. Here, the ground vehicle may be referred to as any vehicle including a vehicle that moves underground as well as a vehicle that moves over land. The vehicle 100 may be a robot in a broad sense, such as a means of movement, and the robot may be moved using wheels, tracks, or other movement modules. In the present disclosure, ground mobility devices such as ground vehicles are mainly described, but, the present disclosure may also be applied to air mobility devices such as an advance air mobility (AAM), aircraft, or the like, and water mobility devices such as ships, submarines, or the like.

The vehicle 100 may be controlled and driven by autonomous driving (also referred to as driver automation), and the autonomous driving may be implemented as semi-autonomous driving or fully autonomous driving. Fully autonomous driving may be provided as autonomous movement in which a processor 130 of the vehicle 100 takes full control without user intervention, even when a driving situation is uncertain. Semi-autonomous driving may be provided as autonomous movement that requires driver intervention depending on specific driving situations. The semi-autonomous driving may be implemented so that the processor 130 transfers control to a user by deactivating autonomous driving when the aforementioned situation occurs, allowing the user to perform manual driving. According to the levels of autonomous driving defined by the Society of Automotive Engineers (SAE), the semi-autonomous driving may correspond to autonomous driving levels 1 through 4, and the fully autonomous driving may correspond to level 5.

The vehicle 100 may communicate with other devices 200 and 300 or another vehicle 400. Other devices may include, for example, a server 200 that supports various controls, state management, and driving of the vehicle 100, an intelligent transportation system (ITS) device 300 for receiving information from an ITS, various types of user devices, or the like. The server 200 may be, for example, an external device operated by a vehicle manufacturer or provided to service autonomous driving, and may receive connected data of the vehicle 100 or transmit data necessary for autonomous driving. The server 200 may transmit various information and software modules used to control the vehicle 100 to the vehicle 100 in response to requests and data transmitted from the vehicle 100 and the user device to support autonomous driving and various services of the vehicle 100.

The ITS device 300 may be, for example, a road side unit (RSU). The ITS device 300 may assist the user in driving his or her own vehicle or support autonomous driving of the vehicle 100 by exchanging vehicle recognition data, driving operation control and state data, environmental data around the vehicle, map data, or the like, through vehicle-to-infrastructure (V2I) communication with the vehicle 100. The vehicle 100 may support manual driving or autonomous driving by exchanging the data listed above through vehicle-to-vehicle (V2V) communication with the other vehicle 400.

The vehicle 100 may communicate with other vehicles or other devices based on cellular communication, wireless access in vehicular environment (WAVE) communication, dedicated short range communication (DSRC), short-range communication, or other communication methods.

For example, the vehicle 100 may use a cellular communication network such as LTE or 5G, a Wi-Fi communication network, a WAVE communication network, or the like, for communicating with the server 200, the ITS device 300, and the other vehicle 400. For another example, DSRC or the like used in the vehicle 100 may be used for communication between vehicles. The communication method between the vehicle 100, the server 200, the ITS device 300, the other vehicle 400, and the user device is not limited to the example embodiments described herein.

FIG. 2 is a diagram showing modules constituting a vehicle;

The vehicle 100 may include a sensor 102, an operating unit 106, a display 108, a load device (also referred to as a load or an electrical load) 114, and a transmitting/receiving unit (also referred to a communicator, a communication interface, a transceiver, a receiver, a transmitter, etc.) 112.

The sensor 102 may be provided with various types of detectors to detect various states and situations occurring in an external environment, an internal system, user operation, and a boarding space of the vehicle 100.

Specifically, the first sensor 102 may be provided with an externally oriented camera 102a, a lidar sensor 102b, a radar sensor 102c, and the like, to recognize dynamic and static objects present outside the vehicle 100. The camera 102a may recognize an external object as an image while the vehicle 100 is in use, generate image data, and transmit the image data to the processor 130. The lidar sensor 102b may generate point cloud data as recognized data of the external object and transmit the point cloud data to the processor 130 to generate three-dimensional (3D) spatial information that identifies at least a shape of the external object. In order to ascertain (e.g., detect) the presence of an external object and its relative distance, speed, direction, or the like, the radar sensor 102c may emit radio waves of a specific frequency around the vehicle 100 and generate radar data through radio waves reflected from the external object. In the present disclosure, the sensor 102 is illustrated as having the lidar sensor 102b, but in other examples, the lidar sensor 102b may not be mounted.

The first sensor 102 may generate object recognition information based on sensing data. The object recognition information may include information on the presence of an object, position information about the object, information on a distance between the vehicle 100 and the object, and information on a relative speed between the vehicle 100 and the object. External objects may be various objects related to the operation of the vehicle 100.

A second sensor 103 may be provided with a positioning sensor 103a, a wheel sensor 103b, an attitude sensor 103c, and the like, to confirm (e.g., detect, identify, sense, determine, etc.) its own location, speed, driving attitude, and the like. The attitude sensor 103c may include a gyro sensor, an angular velocity sensor, an acceleration sensor, or the like. The attitude sensor may be an inertial measurement unit (IMU) sensor and may be equipped with a 3-axis accelerometer and a 3-axis gyroscope. The attitude sensor 103c may measure acceleration in a traveling direction (e.g., longitudinal direction or x-axis), acceleration in a lateral direction (e.g., y-axis), and acceleration in a height direction (e.g., vertical direction or z-axis) of the vehicle 100, and a yaw, a pitch, and a roll as the angular velocity of the vehicle.

The second sensor 103 may generate vehicle driving information based on sensing data. The vehicle driving information may be information generated based on data detected by various sensors installed inside the vehicle. For example, the vehicle driving information may include vehicle attitude information, vehicle speed information, vehicle inclination information, vehicle weight information, vehicle direction information, vehicle battery information, vehicle fuel information, vehicle tire pressure information, vehicle steering information, vehicle interior temperature information, vehicle interior humidity information, pedal position information, vehicle engine temperature information, and the like.

In addition, the vehicle driving information may include route information. The route information may refer to information generated based on a destination input by a vehicle user through the operating unit (also referred to as a user interface, a control panel, a dashboard, an instrument cluster, an instrument panel, etc.) 106. The route information may refer to information that indicates a traveling route from a current position of a host vehicle to a destination on a map, for example, after the destination has been set. If no destination is set, the route information may refer to information including a road on which the host vehicle is currently traveling and a future driving route including one or more roads. The route information may indicate which driving lane(s) for the vehicle to drive on and/or specific path(s) for the vehicle to follow along the road.

A third sensor 105 may include a voice sensor 105a that collects (e.g., detects) voice signals inside the vehicle, a vibration sensor 105b disposed around the occupant (e.g., around a seat), and/or a camera 105c that captures the inside of the vehicle.

The voice sensor 105a may include at least one microphone disposed inside the vehicle, and may collect (e.g., detect) voices and humming sounds expressed by the occupant inside the vehicle to generate a voice signal (e.g., an electrical signal representing a voice).

The vibration sensor 105b may include at least one acceleration sensor or gyro sensor disposed at a position where the occupant's body may touch, and may generate a vibration signal (e.g., an electrical signal that represents a vibration) by measuring the vibrations generated if a steering wheel, a console box, or a dashboard inside the vehicle is touched or tapped.

The camera 105c may capture the inside of the vehicle, and may be disposed to face the front of the upper body of the occupant, thereby generating a video signal by capturing the movements of the occupant.

The operating unit 106 may be configured as a module that is controlled by the user for driving. For example, the operating unit 106 may be a steering wheel for manual driving, an automatic or manual shift transmission, an accelerator pedal, a brake pedal, or the like. The operating unit 106 may be further provided with an interface for enabling or disabling an autonomous driving mode and selecting detailed functions requested by the user so that the user may use an autonomous driving function. In order to receive various requests related to autonomous driving, the operating unit 106 may be configured, for example, as a hard-type interface provided at a predetermined position inside the vehicle 100, or as a soft-type interface that may be touched on the display 108. Depending on the specifications of the autonomous vehicle, at least one of the steering wheel, the transmission, and the pedal may be omitted. For another example, the operating unit 106 may be provided with a module that receives a user's control request for the load device 114 in addition to driving control.

The display 108 may function as a user interface. The display 108 may output and display an operating state, a control state, route/traffic information, remaining energy amount information, content requested by the driver, or the like, of the vehicle 100 by the processor 130. In addition, the display 108 may be configured as a touch screen capable of detecting a driver's input to receive a driver's request to instruct the processor 130.

The load device 114 may be mounted on the vehicle 100 and may be any electrical device that is unrelated to a driving power system such as the wheel driving unit 118 or the like. The load device 114 may be an auxiliary device that receives electrical power from the energy generating unit 110, and may be, for example, an air conditioning system, a lighting system, a seat system, various devices installed in the vehicle 100, or the like. In the present disclosure, a cooling/heating system that cools or heats at least one of a battery, a fuel cell, an internal combustion engine, an air conditioning system, and a specific part of the vehicle 100 may be further included.

The transmitting/receiving unit 112 may support mutual communication with the server 200, the ITS device 300, nearby vehicles 300, and the like. The transmitting/receiving unit 112 may include a module that processes, for example, cellular communication, WAVE, DSRC communication, and the like. In the present disclosure, the transmitting/receiving unit 112 may transmit data generated or stored while driving to the server 200 and receive data and software modules transmitted from the server 200. The transmitting/receiving unit 112 may support communication with an electronic device carried by an occupant inside the vehicle 100. In the present disclosure, the vehicle 100 may transmit and receive data utilized in a method according to the present disclosure to and from the outside through the transmitting/receiving unit 112.

For example, the transmitting/receiving unit 112 may receive traffic signal information from a traffic signal controller and provide the traffic signal information to the processor 130. In addition, the transmitting/receiving unit 112 may receive a control signal from the traffic signal controller and provide the control signal to the processor 130.

In addition, the vehicle 100 may include the energy generating unit 110 and the actuating unit 116.

The energy generating unit 110 may generate and supply power and electric power used in a driving power system and a non-driving power system, such as the actuating unit 116. The non-driving power system may be, for example, the one or more sensors 102, the operating unit 106, the display 108, the load device 114, and the transmitting/receiving unit 112, but is not limited thereto, and may include various components that implement sensing, interface, communication, and convenience functions, excluding components directly involved in driving operations. If the vehicle 100 is driven based on electrical energy, the energy generating unit 110 may be configured as an electric battery charged from the outside, or configured as a combination of an electric battery and a fuel cell that charges the electric battery. In the case of the combination of the electric battery and the fuel cell, the energy generating unit 110 may include a tank that stores materials used to produce electric power for the fuel cell, such as liquefied hydrogen. If the vehicle 100 is driven based on fossil energy, the energy generating unit 110 may be configured as an internal combustion engine. In addition, if the vehicle 100 is a hybrid type, the energy generating unit 110 may be provided as a combination of the internal combustion engine and the electric battery.

The actuating unit 116 may be provided with at least one module that implements driving operations and perform at least one driving operation among longitudinal control such as acceleration and deceleration and lateral control such as steering, according to a user request from the operating unit 106. In order to perform driving operations according to a command of the processor 130 by manual operation of the user or autonomous driving, the actuating unit 116 may be provided with the wheel driving unit 118 and mechanical components and electronic modules for implementing the driving operations in the wheel driving unit 118. If the vehicle 100 is operated based on electrical energy, the actuating unit 116 may include an assembly for transmitting the requested driving operation to the wheel driving unit 118. If the vehicle 100 is operated based on fossil energy, the actuating unit 116 may be provided with a transmission and a gear module that transmit the power of the internal combustion engine.

The wheel driving unit 118 may include a plurality of wheels, a driving force generation module (e.g., engine, motor, etc.) for generating a driving force and applying the driving force to the wheels or transmitting the driving force, a braking module for slowing down the driving of the wheels, and a steering module for carrying out lateral control of the wheels. If the vehicle 100 is driven based on electrical energy, the driving force generating module may be configured as a motor assembly that generates a driving force based on electric power output from the electric battery. The braking module of the electric-based vehicle 100 may further have a regenerative braking function.

A navigation unit (also referred to as a navigation system) 122 may provide navigation information. The navigation information may include at least one of map information, set destination information, route information according to a set destination, information on various objects on the route, lane information, and current vehicle position information.

The navigation unit 122 may receive information from an external device through the transmitting/receiving unit 112 and update previously stored information. The navigation unit 122 may be classified as a sub-component of the operating unit 106.

The vibrator 140 may be provided on a back rest and a seat bottom of a seat and may independently output a vibration signal. The vibrator 140 may be disposed to be embedded in empty spaces of the back rest and the seat bottom of the seat. Each vibrator operates independently under the control of the processor 130 and may output a predetermined vibration signal.

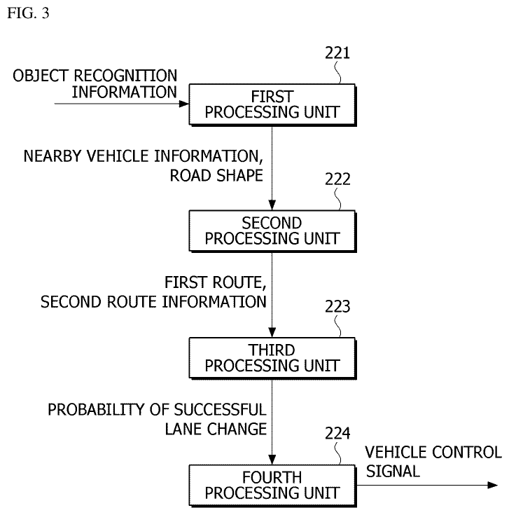

FIG. 3 is a diagram for describing the operation of a vehicle control device. Referring to FIG. 3, a vehicle control device 200 may include a memory 210, a processor 220, and a transmitting/receiving unit 230. The memory 210 and the processor 220 of the vehicle control device 200 may have the same configuration as the memory and the processor in FIG. 2.

The memory 210 may store applications and various types of data for controlling the vehicle control device 10 and load applications or read and record data by a request of the processor 220.

The processor 220 may perform overall control of the vehicle control device 200. The processor 220 may be configured to execute applications and instructions stored in the memory 210.

The processor 220 may include a first processing unit (also referred to as a first processor) 221, a second processing unit (also referred to as a second processor) 222, a third processing unit (also referred to as a third processor) 223, and a fourth processing unit (also referred to as a fourth processor) 224.

The first processing unit 221 may analyze nearby vehicle information and road shape using object recognition information from the sensor unit. The sensor unit may refer to the first sensor unit in FIG. 2. The first processing unit 221 may combine and use various sensors to detect and analyze a location and movement of the nearby vehicle, the road shape, and obstacles. The first processing unit 221 may analyze the location and behavior of the nearby vehicle and the road shape by integrating information collected from cameras, a LiDAR, and a radar.

The camera may recognize an external object using an image while the vehicle is in use, generate image data, and transmit the image data to the processor. The LiDAR sensor may generate point cloud data as recognized data of the external object and transmit the point cloud data to the processor to generate 3D spatial information that identifies at least a shape of the external object. In order to ascertain the presence of an external object and its relative distance, speed, direction, or the like, the radar sensor may emit radio waves of a specific frequency around the vehicle and generate radar data through radio waves reflected from the external object.

For example, the first processing unit 221 may measure a distance and speed of the nearby vehicle using radar data to determine (e.g., calculate) real-time location data.

For example, the first processing unit 221 may scan a 3D shape of the vehicle using point cloud data of the LiDAR to identify the exact location and size of the vehicle.

For example, the first processing unit 221 may recognize visual characteristics of the vehicle (a vehicle type and direction) using the image data of the camera and analyze the type and driving state.

For example, the first processing unit 221 may combine the image data of the camera and radar data to predict an acceleration/deceleration pattern and a possibility of lane change of the nearby vehicle. The first processing unit 221 may determine the possibility of lane change by having the camera recognize when a vehicle in the next lane turns on its turn signal and using a radar to track a change in the speed of the vehicle.

For example, the first processing unit 221 may continuously update a spatial location of the vehicle using point cloud data of the LiDAR and verify whether a predicted route and an actual movement of the vehicle match.

For example, the first processing unit 221 may recognize lane line markers on the road using the image data of the camera and determine the curvature and direction of the lane line.

For example, the first processing unit 221 may use the point cloud data of the LiDAR to construct a 3D map of complex shapes such as slopes and curves of the road.

For example, the first processing unit 221 may recognize a road boundary by distinguishing between moving objects and stationary objects (e.g., guardrails) on the road using radar data.

For example, the first processing unit 221 may detect stationary objects (e.g., broken-down vehicles) and dynamic objects (e.g., pedestrians, bicycles) on the road using the point cloud data of the LiDAR.

For example, the first processing unit 221 may recognize traffic signals and signs using the image data of the camera and reflect the recognized traffic signals and signs on the driving route of the vehicle.

For example, the first processing unit 221 may reliably detect obstacles even in weather conditions such as rain or fog using the radar data and transmit data on the detected obstacles to the vehicle control system.

The first processing unit 221 may combine data from each sensor to provide data for integrated situational awareness of a surrounding environment. For example, by fusing data from an object simultaneously detected by the LiDAR and the camera, both the exact location and visual characteristics of the object may be identified, and by fusing the camera and the radar, the speed and distance of the object may be accurately predicted, allowing linkage to a collision avoidance system of the vehicle.

The second processing unit 222 may generate a first route and a second route for driving the host vehicle according to the nearby vehicle information and road shape. The first route may be a lane keeping route, and the second route may be a lane change route.

The second processing unit 222 may determine (e.g., calculate) a driving direction of the host vehicle based on the road shape as a first potential and determine (e.g., calculate) the location of the nearby vehicle as a second potential to generate a potential field.

The second processing unit 222 may generate the first route and the second route, respectively, according to a sum potential of the first potential and the second potential in the potential field.

A potential field technique aims to avoid obstacles while efficiently moving to a target point in a given space, under the assumption that the target point generates a pulling force (positive potential) and the obstacle generates a pushing force (negative potential), a route along which the vehicle may move by a combined force of the two forces may be generated.

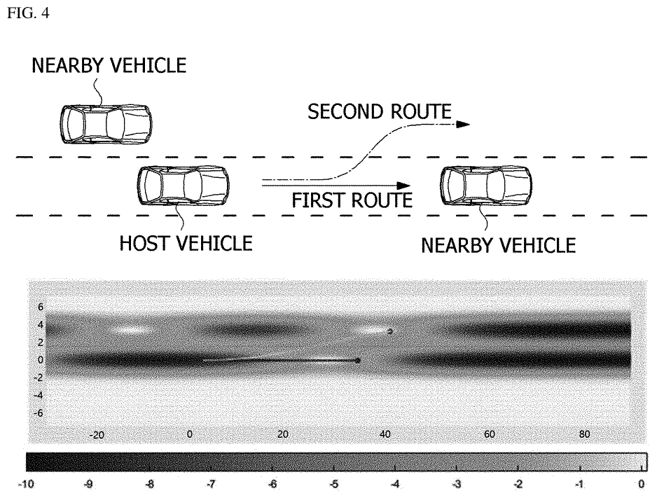

FIG. 4 is a view for describing the operation of the second processing unit. Referring to FIG. 4 together, the second processing unit 222 may generate a potential field by providing a force that pulls the shape of the road on which the host vehicle is traveling along the driving direction and defining the nearby vehicle as a pushing force.

The second processing unit 222 may provide a first potential to generate an attractive force that pulls the vehicle toward the target point in the driving direction of the host vehicle according to the road shape. The size of the attractive force may be proportional to a distance between the vehicle and the target point.

The second processing unit 222 may provide a second potential to generate a repulsive force that pushes the vehicle away from an obstacle such as the nearby vehicle or a stationary object. The size of the repulsive force may be set to increase as the vehicle gets closer to the obstacle.

The second processing unit 222 may define the pulling force and the pushing force for each specific location by adding up the first potential and the second potential, and may generate the potential field by differently expressing brightness, color, and the like, according to the size of the added value.

The third processing unit 223 may determine (e.g., calculate) a probability (e.g., a score) of lane change success using nearby vehicle information. The third processing unit may determine (e.g., calculate) the probability of lane change success using the location and speed of the host vehicle and the location and speed of the nearby vehicle. The probability may be, for example, a score (e.g., a probability score).

The third processing unit 223 may determine (e.g., calculate) a probability of adjacent vehicle yielding and a probability of collision-free lane change of the nearby vehicle using the location and speed of the host vehicle and the location and speed of the nearby vehicle, and may determine (e.g., calculate) the probability of lane change success according to the probability of adjacent vehicle yielding and the probability of collision-free lane change.

The term “yield” as used herein may refer to any action of one vehicle (e.g., the target vehicle) to facilitate (e.g., help, allow, etc.) another vehicle's (e.g., the host vehicle's) lane change (e.g., into the target vehicle's driving lane). Yielding may include but is not limited to, for example, decelerating (e.g., to make room for the host vehicle's lane change if the host vehicle is ahead in an adjacent lane of the target vehicle), accelerating (e.g., to make room for the host vehicle's lane change if the host vehicle is trailing in an adjacent lane of the target vehicle), changing lanes (e.g., to another lane farther away from the host vehicle), cruising at constant speed (e.g., if the host vehicle is ahead in an adjacent lane of the target vehicle and there is already enough room in front of the target vehicle for the host vehicle's lane change, and the target vehicle does not accelerate to close the gap), etc.

The third processing unit 223 may determine (e.g., calculate) the probability of adjacent vehicle yielding (e.g., decelerating to make room for the host vehicle) according to an expected time to collision (TTC) with the nearby vehicle.

The third processing unit 223 may determine (e.g., calculate) the probability of collision-free lane change according to a relative distance from the nearby vehicle.

The probability of adjacent vehicle yielding (e.g., decelerating to make room for the host vehicle) may refer to a probability that the nearby vehicle yields (e.g., decelerates to make room for the host vehicle) when the host vehicle intends to enter the new lane (e.g., the lane on which the nearby vehicle is traveling), and the probability of collision-free lane change may refer to a probability (e.g., a score) that the host vehicle safely finishes the lane change. The probability of yielding, for example, may be affected by the target driver's reaction time, which may be related to the time to collision value between the host vehicle and the target vehicle.

In addition, the probability of lane change success may refer to a probability that lane change is successful according to the probability of adjacent vehicle yielding (e.g., decelerating to make room for the host vehicle) and the probability of collision-free lane change.

The probability of adjacent vehicle yielding (e.g., decelerating to make room for the host vehicle) may be used in the same meaning as a probability of yielding (e.g., decelerating to make room for the host vehicle), the probability of collision-free lane change may be used in the same meaning as a probability of safe lane change, and the probability of lane change success may be used in the same meaning as a probability of successful lane change.

The third processing unit 223 may determine (e.g., calculate) the probability of lane change success by combining the probability of adjacent vehicle yielding (e.g., decelerating to make room for the host vehicle) and the probability of collision-free lane change.

The third processing unit 223 may determine (e.g., calculate) the probability of lane change success by applying a decision-making modeling method.

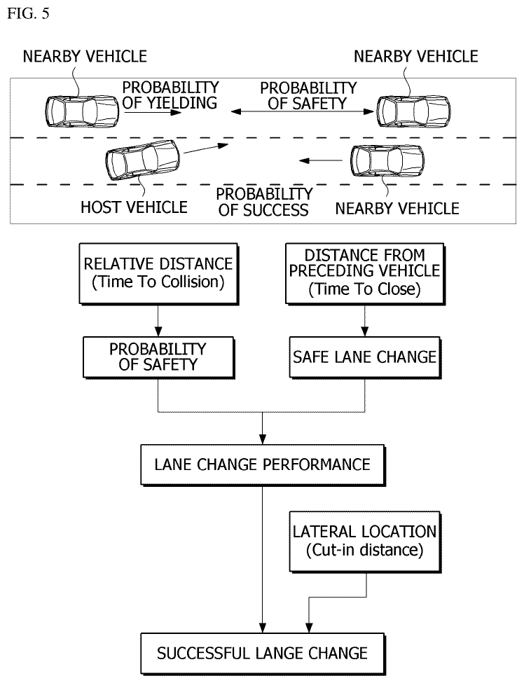

FIG. 5 is a view for describing the operation of the third processing unit. Referring to FIG. 5 together, the third processing unit 223 may probabilistically predict whether lane change is successful or not by evaluating the behavior and safety of the nearby vehicle through a decision-making model. This process may be performed using probabilistic modeling (e.g., Bayesian networks or decision trees).

The third processing unit 223 may determine (e.g., calculate) the probability of adjacent vehicle yielding (e.g., decelerating to make room for the host vehicle) by considering the speed and distance of an adjacent vehicle, an entry timing of the host vehicle, and the like. The third processing unit 223 may determine that the probability of yielding (e.g., decelerating to make room for the host vehicle) is high when the nearby vehicle is slowly traveling and has a secured sufficient distance and time, and may determine that the probability of yielding (e.g., decelerating to make room for the host vehicle) is low when the nearby vehicle is quickly approaching or an interval between the vehicles is small. The third processing unit 223 may determine that the probability of yielding (e.g., decelerating to make room for the host vehicle) is lower as the speed of the nearby vehicle is faster, and may determine that the probability of yielding (e.g., decelerating to make room for the host vehicle) is lower as the distance between the nearby vehicle and the host vehicle is closer. That is, the third processing unit 223 may determine (e.g., calculate) an expected time to collision between the host vehicle and the nearby vehicle, and may determine (e.g., calculate) a higher probability of yielding (e.g., decelerating to make room for the host vehicle) as the expected time to collision increases.

The nearby vehicle considered in a process of determining (e.g., calculating) the probability of yielding (e.g., decelerating to make room for the host vehicle) may refer to a rear vehicle located on a lane to which the host vehicle intends to change.

The third processing unit 223 may determine (e.g., calculate) the probability of collision-free lane change by evaluating the risk of collision between the host vehicle and the nearby vehicle and the stability after entering the lane. The third processing unit 223 may determine that the probability of safe lane change is high when the host vehicle maintains sufficient acceleration and a safe distance from the nearby vehicle is secured, and may determine that the probability of safe lane change is low when the speed change of the nearby vehicle is large or a driving interval is very small. The third processing unit 223 may determine that the probability of safe lane change is lower as the distance between the nearby vehicle and the host vehicle is closer, and may determine that the probability of safe lane change is higher as the acceleration of the host vehicle is higher. In addition, the third processing unit 223 may determine that the probability of safe lane change is lower as the acceleration of the nearby vehicle is higher or the speed change is larger. That is, the third processing unit 223 may determine (e.g., calculate) a relative distance (Time to Close) expressed as time based on the difference in distance and speed with nearby vehicles, and may determine (e.g., calculate) a higher probability of safe lane change as the relative distance increases.

The nearby vehicle considered in a process of the probability of safe lane change may refer to a preceding vehicle (e.g., a leading vehicle) located in a driving lane of the host vehicle or in a lane to which the host vehicle intends to change.

The third processing unit 223 may determine (e.g., calculate) the probability of successful lane change by combining the probability of yielding (e.g., decelerating to make room for the host vehicle) and the probability of safe lane change. For example, the third processing unit 223 may determine that the probability of lane change success is very high when both the probability of yielding (e.g., decelerating to make room for the host vehicle) and the probability of safe lane change are high. Alternatively, the third processing unit 223 may determine that there may be a risk in changing lanes and thus caution is required when at least one of the probability of yielding (e.g., decelerating to make room for the host vehicle) and the probability of successful lane change is not sufficiently high. Alternatively, the third processing unit 223 may determine that lane changing is not possible when both the probability of yielding (e.g., decelerating to make room for the host vehicle) and the probability of successful lane change are low.

The third processing unit 223 may determine (e.g., calculate) the probability of lane change success in real time based on the information collected from the sensor unit and transmit the possibility to the fourth processing unit 224.

The fourth processing unit 224 may generate a vehicle control signal to control the behavior of the host vehicle for each of the first route and the second route based on the probability of lane change success.

The fourth processing unit 224 may determine (e.g., calculate) the vehicle control signal on the first route and the second route by applying the probability of lane change success as a weight. The fourth processing unit 224 may determine (e.g., calculate) the vehicle control signal by applying the probability of lane change success for each control point of the first route and the second route as a weight.

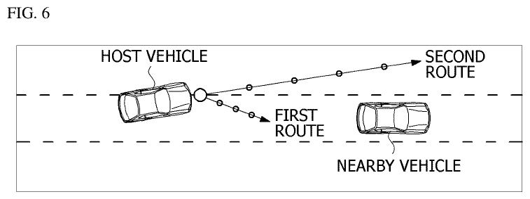

FIG. 6 is a view for describing the operation of the fourth processing unit. Referring to FIG. 6 together, the fourth processing unit 224 may generate a vehicle control signal for each route by simultaneously considering two main control goals, that is, lane keeping and lane change. The fourth processing unit 224 may control the vehicle by selecting an optimal route in real time according to road conditions while simultaneously tracking multi-references such as lane keeping and lane changing by utilizing Contingency MPC (emergency preparedness model predictive control).

For example, the fourth processing unit 224 may simultaneously manage two routes to prepare for unexpected situations (e.g., a slow vehicle, road obstacles, a vehicle that suddenly stops, and the like) and generate an optimal control input by reflecting constraints for each route.

The first route is a lane keeping route, which may refer to a route along which the vehicle maintains a lane in which the vehicle is currently traveling.

The second route is a lane change route, which may refer to a route along which the vehicle may change lanes to a next lane if necessary.

The fourth processing unit 224 may predict a state (e.g., the location, speed, acceleration, and/or the like) during a certain prediction section (e.g., horizon) using a dynamic model of the vehicle (e.g., the host vehicle). The dynamic model of the vehicle (e.g., the host vehicle) may predict its future location according to control inputs such as the acceleration, steering angle, or the like, of the vehicle.

The fourth processing unit 224 may set the first route and the second route as reference routes, respectively, and define a target state (e.g., the location, speed, and/or acceleration) of the vehicle for each route. The fourth processing unit 224 may set (e.g., analyze) the first route in which the vehicle moves along a set driving trajectory within the same lane, and the second route in which the vehicle maintains a smooth curvature while moving to the next lane.

The fourth processing unit 224 may set an objective function as shown in the following Equation 1 in a way to reduce or minimize an error and control cost (e.g., time or resource required to execute one or more vehicle control operations) as the vehicle follows one of the two routes (e.g., the first route or the second route).

$$J ( k ) = \sum ( {( {X}_{ref} - \overline{x} ( k ) )}^{T} [ \begin{matrix}{P}^{N} Q & 0 \\ 0 & {P}^{O} Q\end{matrix} ] ( {X}_{ref} - \tilde{x} ( k ) ) ) + Δ {\tilde{u} ( k )}^{T} [ \begin{matrix}{P}^{N} R & 0 \\ 0 & {P}^{C} R\end{matrix} ] Δ \tilde{u} ( k ) \qquad [ Equation 1 ]$$

In Equation 1, X_{ref} represents a target location (e.g., a predicted state such as a target location, a target speed, and/or a target acceleration) to which the vehicle intends to move. The target location (e.g., target state) may be also referred to as a reference location (e.g., reference state). X_{ref} may be set to refer to the first route or the second route (e.g., depending on which route being analyzed).

In Equation 1, \tilde{x}(k) is a predicted state (e.g., a predicted location, a predicted speed, a predicted acceleration) of the vehicle, and may refer to a predicted value of a state of the vehicle at point k. The fourth processing unit 224 may control the vehicle to come as close as possible to the target route defined by X_{ref}.

In Equation 1, P^{N} may refer to a probability (e.g., a probability score) of successful lane change, and P^{C} may be a probability (e.g., a probability score) that a dangerous situation occurs and may refer to a probability that an unexpected emergency situation occurs on the road. The higher the probability that an emergency situation occurs, the more likely the vehicle is to consider an alternative route to deal with the corresponding situation.

In Equation 1, Q is a state error weight matrix, and may refer to a weight for a state error (e.g., a distance from the predicted location to the target location) of the vehicle. As this value is larger, the vehicle may be forced to come as close to the target route as possible (e.g., attempt to get closer to the target.

In Equation 1, Δũ(k) is a control input variation, and may refer to a parameter that reduces or minimizes the amount of change in the control signal (e.g., acceleration, steering, or the like) over time.

In Equation 1, R is a control input weight matrix, and may assign weights to changes in control input. As this value is larger, the tendency to minimize changes in the control signal is stronger.

The objective function of Equation 1 is designed to prepare for unexpected situations and minimize changes in the control signals while the vehicle moves along the first route or the second route.

The fourth processing unit 224 may simultaneously reflect (e.g., apply) the probability of successful lane change and a probability of occurrence of an emergency situation in the first route and the second route to optimize the route and control of the vehicle, thereby assigning different importance levels (e.g., weights) to routes depending on the situation.

The fourth processing unit 224 may minimize a difference between the predicted vehicle state and the target route according to the objective function. The fourth processing unit 224 may assign a higher weight to following the second route if the probability of successful lane change is higher. On the other hand, if the probability of occurrence of an emergency situation is high, the fourth processing unit 224 may assign a higher weight to the vehicle following the first route.

In addition, the fourth processing unit 224 may minimize the control input variation according to the objective function. For example, since when steering or accelerator pedal operation changes too abruptly, the riding comfort is degraded, in order to minimize the degradation of the riding comfort, the fourth processing unit 224 may optimize the objective function. Even in this case, the fourth processing unit 224 may induce changes in the control signal to be minimized according to the situation by reflecting the probability of successful lane change and the probability of occurrence of an emergency situation.

The fourth processing unit 224 may flexibly select the first route or the second route according to the situation by optimizing the value of the objective function, and may determine (e.g., calculate) the vehicle control signal to perform safe and efficient driving by minimizing changes in the control signal.

The fourth processing unit 224 may predict a future state of the vehicle through the objective function, and then select an optimal route among the two routes to determine (e.g., calculate) the vehicle control signal (e.g., the steering angle and acceleration). When an obstacle is detected, a vehicle control signal optimized to switch to the second route may be generated, and when an emergency situation is detected during a lane change, a control signal optimized to switch to the first route may be generated.

The fourth processing unit 224 may control the behavior of the vehicle by applying the optimized vehicle control signal to the vehicle in real time.

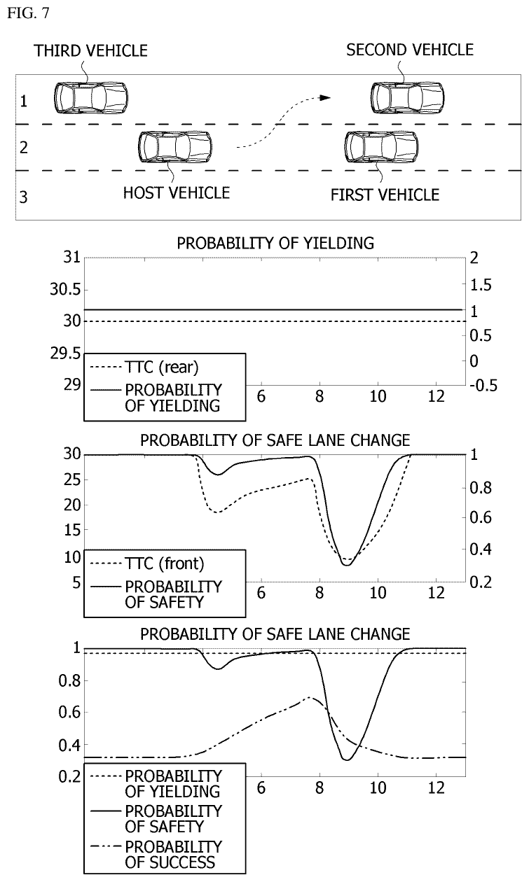

FIGS. 7 through 10 are operation concept views of a vehicle control device.

In FIGS. 7 through 10, a vehicle located in front of a host vehicle on a driving lane of the host vehicle is defined as a first vehicle, a vehicle located in front of the host vehicle on a lane to be changed is defined as a second vehicle, and a vehicle located behind the host vehicle on the lane to be changed is defined as a third vehicle.

FIG. 7 shows a situation where the first to third vehicles are all traveling at a constant speed. The x-axes of the graphs shown in FIGS. 7-10 may represent time (e.g., in seconds), and the y-axes of the graphs may represent probabilities (e.g., between 0 and 1, inclusive) or time to collision values (e.g., in seconds). The vehicle control device may determine (e.g., calculate) an expected time to collision (TTC (rear)) between the third vehicle and the host vehicle, and determine (e.g., calculate) a probability of yielding (e.g., decelerating to make room for the host vehicle) according to the expected time to collision. The vehicle control device may determine (e.g., calculate) a relative distance (TTC (front)) between the first vehicle and the second vehicle and determine (e.g., calculate) a probability of safe lane change according to the relative distance.

Since the third vehicle is traveling at the constant speed, the probability of yielding (e.g., decelerating to make room for the host vehicle) may be determined (e.g., calculated) as 100% throughout an entire lane change process.

In the case of the probability of safe lane change, since the first vehicle and the second vehicle are traveling at the constant speed, the probability of yielding (e.g., decelerating to make room for the host vehicle) is initially determined (e.g., calculated) as 100%, but as the host vehicle accelerates to change lanes, the relative distance from the second vehicle decreases, and accordingly, the probability of safe lane change decreases.

The vehicle control device may determine (e.g., calculate) the probability of successful lane change by comprehensively considering the probability of yielding (e.g., decelerating to make room for the host vehicle) and a probability of safe lane change, and applies the probability of successful lane change as a weight to determine (e.g., calculate) a vehicle control signal on the first route and the second route. A lane change is attempted according to the vehicle control signal determined (e.g., calculated) based on the probability of successful lane change of the vehicle control device, and the probability of successful lane change gradually increases during the lane change process and thus it may be confirmed that the lane change is completed.

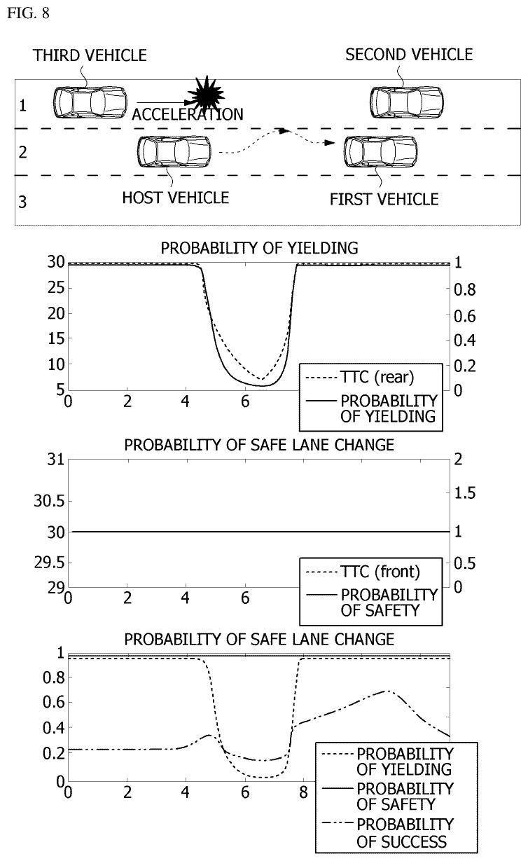

FIG. 8 shows a situation where the first vehicle and the second vehicle are traveling at a constant speed while the third vehicle is travelling at an accelerated speed. The vehicle control device may determine (e.g., calculate) an expected time to collision (TTC (rear)) between the third vehicle and the host vehicle, and determine (e.g., calculate) a probability of yielding (e.g., decelerating to make room for the host vehicle) according to the expected time to collision. The vehicle control device may determine (e.g., calculate) a relative distance (TTC (front)) between the first vehicle and the second vehicle and determine (e.g., calculate) a probability of safe lane change according to the relative distance.

The probability of yielding (e.g., decelerating to make room for the host vehicle) may be initially determined (e.g., calculated) as 100%, but from a time point when the third vehicle accelerates, the expected time to collision with the third vehicle decreases, and accordingly, the probability of yielding (e.g., decelerating to make room for the host vehicle) decreases.

In the case of the probability of safe lane change, since the first vehicle and the second vehicle are traveling at the constant speed, the probability of safe lane change may be determined (e.g., calculated) as 100% throughout the entire lane change process.

The vehicle control device may determine (e.g., calculate) the probability of successful lane change by comprehensively considering the probability of yielding (e.g., decelerating to make room for the host vehicle) and a probability of safe lane change, and apply the probability of successful lane change as a weight to determine (e.g., calculate) a vehicle control signal on the first route and the second route. The probability of successful lane change decreases at a time point when the third vehicle accelerates, and then increases again at a time point when the third vehicle stops accelerating. The vehicle control device attempts to change lanes according to the vehicle control signal determined (e.g., calculated) based on the probability of successful lane change, and the probability of successful lane change gradually increases during the lane change process and thus it may be confirmed that the lane change is completed.

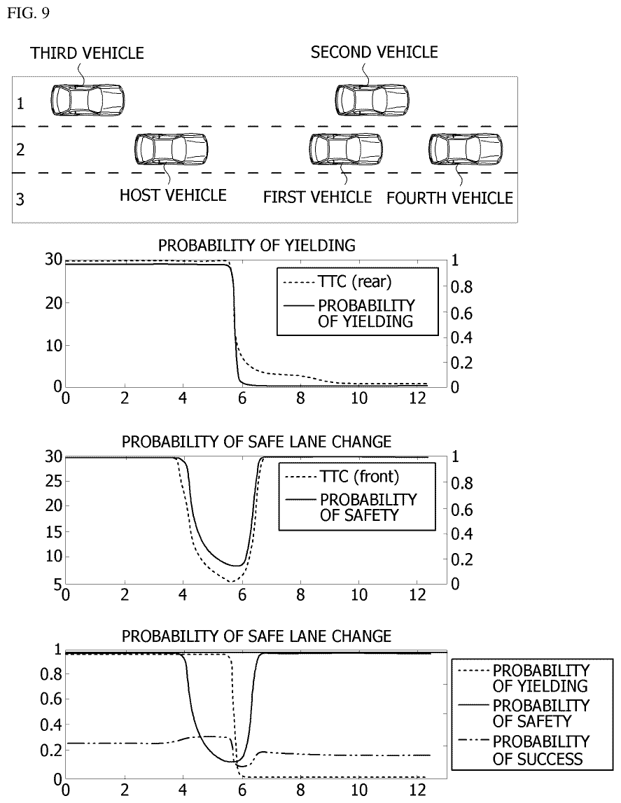

FIG. 9 shows a situation where the second and third vehicles are traveling at a constant speed while the first vehicle is traveling at a decelerated speed. The vehicle control device may determine (e.g., calculate) an expected time to collision (TTC (rear)) between the third vehicle and the host vehicle, and determine (e.g., calculate) a probability of yielding (e.g., deceleration) (e.g., by the third vehicle) according to the expected time to collision. The vehicle control device may determine (e.g., calculate) a relative distance (TTC (front)) between the first vehicle and the second vehicle and determine (e.g., calculate) a probability of safe lane change according to the relative distance.

The probability of yielding (e.g., decelerating to make room for the host vehicle) may be initially determined (e.g., calculated, initiated, etc.) as 100%, but as the first vehicle is traveling at the decelerated speed, the host vehicle may be also traveling at a decelerated speed, and accordingly, the expected time to collision with the third vehicle may decrease, and the probability of yielding (e.g., decelerating by the third vehicle to make room for the host vehicle) may decrease.

The probability of safe lane change may be initially determined (e.g., calculated, initialized, etc.) as 100%, but as the first vehicle is travelling at the decelerated speed, the relative distance decreases, and the probability of safe lane change decreases accordingly. However, as the host vehicle is traveling at the decelerated speed, the relative distance from the first vehicle increases again, and the probability of safe lane change increases accordingly.

The vehicle control device may determine (e.g., calculate) the probability of successful lane change by comprehensively considering the probability of yielding (e.g., decelerating to make room for the host vehicle) and a probability of safe lane change, and apply the probability of successful lane change as a weight to determine (e.g., calculate) a vehicle control signal on the first route and the second route. The probability of successful lane change decreases when the first vehicle slows down. The vehicle control device attempts to change lanes according to the vehicle control signal determined (e.g., calculated) based on the probability of successful lane change, but the probability of successful lane change does not increase during the lane change process, and thus it may be confirmed that the lane change is abandoned.

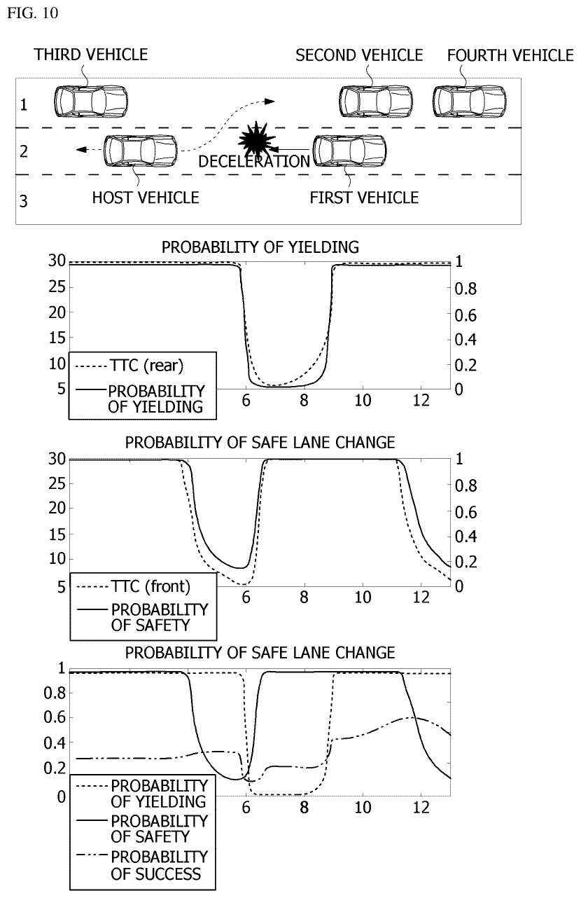

FIG. 10 shows a situation where the first vehicle and the third vehicle are traveling at a decelerated speed while the second vehicle is traveling at a constant speed. The vehicle control device may determine (e.g., calculate) an expected time to collision (TTC (rear)) between the third vehicle and the host vehicle, and determine (e.g., calculate) a probability of yielding (e.g., decelerating to make room for the host vehicle) according to the expected time to collision. The vehicle control device may determine (e.g., calculate a relative distance (TTC (front)) between the first vehicle and the second vehicle and determine (e.g., calculate) a probability of safe lane change according to the relative distance.

As the first vehicle is traveling at the decelerated speed, the host vehicle is also traveling at a decelerated speed, and accordingly, the expected time to collision with the third vehicle decreases, and the probability of yielding (e.g., decelerating to make room for the host vehicle) decreases. However, the expected time to collision increases again at (or after) a time point when the third vehicle starts traveling at a decelerated speed, and accordingly, the probability of yielding (e.g., decelerating to make room for the host vehicle) may increase.

The probability of safe lane change may be initially determined (e.g., calculated, initialized, etc.) as 100%, but as the first vehicle is travelling at the decelerated speed, the relative distance may decrease, and the probability of safe lane change may also decrease accordingly. However, as the host vehicle is traveling at the decelerated speed, the relative distance from the first vehicle may increase again, and the probability of safe lane change may increase accordingly.

The vehicle control device may determine (e.g., calculate) the probability of successful lane change by comprehensively considering the probability of yielding (e.g., decelerating to make room for the host vehicle) and a probability of safe lane change, and apply the probability of successful lane change as a weight to determine (e.g., calculate) one or more vehicle control signals for the first route and the second route. The probability of successful lane change decreases at a time point when the first vehicle starts traveling at the decelerated speed, and increases again at a time point when the third vehicle starts traveling at the decelerated speed. The vehicle control device attempts to change lanes according to a vehicle control signal determined (e.g., calculated) based on the probability of successful lane change, and the probability of successful lane change increases as the probability of yielding (e.g., decelerating to make room for the host vehicle) increases and thus it may be confirmed that the lane change is completed.

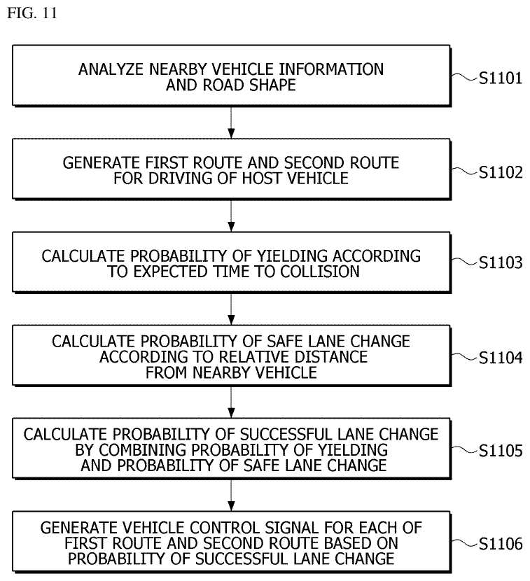

FIG. 11 is a flowchart of a method of controlling a vehicle. Referring to FIG. 11, the processor analyzes nearby vehicle information and road shape using object recognition information from the sensor unit (S1101).

The processor may generate a first route and a second route for driving the host vehicle according to the nearby vehicle information and the road shape. For example, the processor may determine (e.g., calculate) a driving direction of the host vehicle based on the road shape as a first potential and determine (e.g., calculate) the location of the nearby vehicle as a second potential to generate a potential field, and generate the first route and the second route, respectively, according to the sum potential of the first potential and the second potential in the potential field (S1102).

The processor may determine (e.g., calculate) the expected time to collision (TTC) with a nearby vehicle using the location and speed of the host vehicle and the location and speed of the nearby vehicle, and determine (e.g., calculate) the probability of yielding (e.g., decelerating to make room for the host vehicle) according to the expected time to collision (S1103).

The processor may determine (e.g., calculate) the probability of safe lane change according to a relative distance from the nearby vehicle determined (e.g., calculated) using the location and speed of the host vehicle and the location and speed of the nearby vehicle (S1104).

The processor may determine (e.g., calculate) a probability of successful lane change by combining the probability of yielding (e.g., decelerating to make room for the host vehicle) and the probability of safe lane change (S1105).

The processor generates a vehicle control signal to control the behavior of the host vehicle for each of the first route and the second route based on the probability of successful lane change. The processor may determine (e.g., calculate) a vehicle control signal by applying the probability of successful lane change as a weight to each control point of the first route and the second route (S1106).

According to an aspect of the present disclosure, there is provided a vehicle control device including one or more processors and a memory storing one or more programs executed by the one or more processors, in which the processor includes a first processing unit configured to analyze nearby vehicle information and a road shape using object recognition information from a sensor unit, a second processing unit configured to generate a first route and a second route for driving of a host vehicle according to the nearby vehicle information and the road shape, a third processing unit configured to calculate a probability of lane change success using the nearby vehicle information, and a fourth processing unit configured to generate a vehicle control signal for controlling behavior of the host vehicle for each of the first route and the second route based on the probability of lane change success.

The first route may be a lane keeping route, and the second route may be a lane change route.

The second processing unit may generate a potential field by calculating a driving direction of the host vehicle based on the road shape as a first potential and calculating a location of the nearby vehicle as a second potential.

The second processing unit may generate the first route and the second route, respectively, according to a sum potential of the first potential and the second potential in the potential field.

The third processing unit may calculate the probability of lane change success using a location and speed of the host vehicle and a location and speed of the nearby vehicle.

The third processing unit may calculate a probability of adjacent vehicle yielding and a probability of collision-free lane change of the nearby vehicle using the location and speed of the host vehicle and the location and speed of the nearby vehicle and calculate the probability of lane change success according to the probability of adjacent vehicle yielding and the probability of collision-free lane change.

The third processing unit may calculate the probability of adjacent vehicle yielding according to an expected time to collision (TTC) with the nearby vehicle.

The third processing unit may calculate the probability of collision-free lane change according to a relative distance from the nearby vehicle.

The fourth processing unit may calculate the vehicle control signal on the first route and the second route by applying the probability of lane change success as a weight.

The fourth processing unit may calculate the vehicle control signal by applying the probability of lane change success as a weight to each control point of the first route and the second route.

According to another aspect of the present disclosure, there is provided a method of controlling a vehicle that is performed by a computing device including one or more processors and a memory storing one or more programs executed by the one or more processors, including analyzing, by the processor, nearby vehicle information and a road shape using object recognition information from a sensor unit, generating, by the processor, a first route and a second route for driving of a host vehicle according to the nearby vehicle information and the road shape, calculating, by the processor, a probability of lane change success using the nearby vehicle information, and generating, by the processor, a vehicle control signal for controlling behavior of the host vehicle for each of the first route and the second route based on the probability of lane change success.

The first route may be a lane keeping route, and the second route may be a lane change route.

The generating of the first route and the second route may include generating a potential field by calculating a driving direction of the host vehicle based on the road shape as a first potential and calculating a location of the nearby vehicle as a second potential.

The generating of the first route and the second route may include generating the first route and the second route, respectively, according to a sum potential of the first potential and the second potential in the potential field.

The calculating of the probability of lane change success may include calculating the probability of lane change success using a location and speed of the host vehicle and a location and speed of the nearby vehicle.

The calculating of the probability of lane change success may include calculating a probability of adjacent vehicle yielding and a probability of collision-free lane change of the nearby vehicle using the location and speed of the host vehicle and the location and speed of the nearby vehicle and calculating the probability of lane change success according to the probability of adjacent vehicle yielding and the probability of collision-free lane change.

The calculating of the probability of lane change success may include calculating the probability of adjacent vehicle yielding according to an expected time to collision (TTC) with the nearby vehicle.

The calculating of the probability of lane change success may include calculating the probability of collision-free lane change according to a relative distance from the nearby vehicle.

The generating of the vehicle control signal may include calculating the vehicle control signal on the first route and the second route by applying the probability of lane change success as a weight.

The generating of the vehicle control signal may include calculating the vehicle control signal by applying the probability of lane change success as a weight to each control point of the first route and the second route.

The term “unit” used in the present example embodiments refers to software components or hardware components such as a field-programmable gate array (FPGA) or an application specific integrated circuit (ASIC), and “unit” performs certain functions. However, the “unit” is not limited to software or hardware. The “unit” may be configured to reside in an addressable storage medium, or may be configured to reproduce one or more processors. Therefore, for example, “unit” includes components such as software components, object-oriented software components, class components, and task components, and includes processes, functions, attributes, procedures, sub-routines, segments of program code, drivers, firmware, micro code, circuits, data, a database, data structures, tables, arrays, and variables. Functions provided in the components and the “unit” may be combined into smaller numbers of components and “units,” or may be further divided into additional components and “units.” Furthermore, the components and “units” may be implemented to reproduce one or more CPUs in a device or a security multimedia card.

With a vehicle control device and method according to the present disclosure, it is possible to safely and efficiently establish a driving strategy of a vehicle.

In addition, it is possible to detect a dangerous situation in real time and establish a driving strategy using a safe route among multiple routes.

In addition, it is possible to establish a driving strategy that reflects the lane change possibility and stability according to an actual driving pattern.

Although one or more example embodiments of the present disclosure have been described herein, it is understood that those skilled in the art may make various changes and modifications to the present disclosure without departing from the spirit and scope of the present disclosure set forth in the claims below.

What is claimed is:

1. A vehicle control device for a host vehicle, the vehicle control device comprising:
a plurality of processors comprising a first processor, a second processor, a third processor, and a fourth processor; and
a memory storing at least one instruction,
wherein the at least one instruction is configured, when executed by the first processor communicating with the memory, to cause the vehicle control device to:
identify, based on object recognition information received from a sensor of the host vehicle:
target vehicle information describing a target vehicle within a threshold distance from the host vehicle; and
a shape of a road that the host vehicle is traveling on,
wherein the at least one instruction is configured, when executed by the second processor communicating with the memory, to further cause the vehicle control device to:
generate, based on the target vehicle information and the shape of the road, a first route and a second route for the host vehicle;
wherein the at least one instruction is configured, when executed by the third processor communicating with the memory, to further cause the vehicle control device to:
determine, based on the target vehicle information, a probability score of a successful lane change of the host vehicle, and
wherein the at least one instruction is configured, when executed by the fourth processor communicating with the memory, to further cause the vehicle control device to:
generate, based on the probability score of the successful lane change, a vehicle control signal for controlling an operation of the host vehicle for each of the first route and the second route; and
control, based on the vehicle control signal, the operation of the host vehicle.

2. The vehicle control device of claim 1, wherein the first route is associated with staying on a current driving lane of the host vehicle and the second route is associated with a lane change.

3. The vehicle control device of claim 1, wherein the at least one instruction is configured, when executed by the second processor communicating with the memory, to cause the vehicle control device to generate the first route and the second route by:
generating a potential field by:
determining, based on a driving direction of the host vehicle based on the shape of the road, a first potential of the potential field; and
determining, based on a location of the target vehicle, a second potential of the potential field.

4. The vehicle control device of claim 3, wherein the at least one instruction is configured, when executed by the second processor communicating with the memory, to cause the vehicle control device to generate the first route and the second route by:
generating the first route and the second route based on a sum potential of the first potential and the second potential in the potential field.

5. The vehicle control device of claim 1, wherein the at least one instruction is configured, when executed by the third processor communicating with the memory, to cause the vehicle control device to determine the probability score of the successful lane change by:
determining the probability score of the successful lane change further based on a location of the host vehicle, a speed of the host vehicle, a location of the target vehicle, and a speed of the target vehicle.

6. The vehicle control device of claim 5, wherein the target vehicle is a first target vehicle, and
wherein the at least one instruction is configured, when executed by the third processor communicating with the memory, to cause the vehicle control device to determine the probability score of the successful lane change by:
based on the location of the host vehicle, the speed of the host vehicle, the location of the target vehicle, and the speed of the target vehicle, determining:
a probability score of a second target vehicle decelerating, wherein the second target vehicle is traveling in an adjacent driving lane of the target vehicle; and
a probability score of a collision-free lane change of the first target vehicle; and
determining the probability score of the successful lane change of the host vehicle further based on the probability score of the second target vehicle decelerating and the probability score of the collision-free lane change of the first target vehicle.

7. The vehicle control device of claim 6, wherein the at least one instruction is configured, when executed by the third processor communicating with the memory, to cause the vehicle control device to determine the probability score, of the second target vehicle decelerating, by:
determining, based on an expected time to collision between the host vehicle and the first target vehicle, the probability score of the second target vehicle decelerating.

8. The vehicle control device of claim 6, wherein the at least one instruction is configured, when executed by the third processor communicating with the memory, to cause the vehicle control device to determine the probability score of the collision-free lane change of the first target vehicle by:
determining, based on a relative distance between the host vehicle and the first target vehicle, the probability score of the collision-free lane change of the first target vehicle.

9. The vehicle control device of claim 1, wherein the at least one instruction is configured, when executed by the fourth processor communicating with the memory, to cause the vehicle control device to generate the vehicle control signal by:
using the probability score of the successful lane change as a weight.

10. The vehicle control device of claim 9, wherein the at least one instruction is configured, when executed by the fourth processor communicating with the memory, to cause the vehicle control device to generate the vehicle control signal by:
applying the probability score of the successful lane change as the weight to each control point of the first route and the second route.

11. A method performed by an apparatus of a host vehicle, the method comprising:
identifying, by one or more processors based on object recognition information received from a sensor of the host vehicle:
target vehicle information describing a target vehicle within a threshold distance from the host vehicle, and
a shape of a road that the host vehicle is traveling on;
generating, by the one or more processors based on the target vehicle information and the shape of the road, a first route and a second route for the host vehicle;
determining, by the one or more processors based on the target vehicle information, a probability score of a successful lane change of the host vehicle;
generating, by the one or more processors based on the probability score of the successful lane change, a vehicle control signal for controlling an operation of the host vehicle for each of the first route and the second route; and
controlling, based on the vehicle control signal, the operation of the host vehicle.

12. The method of claim 11, wherein the first route is associated with staying on a current driving lane of the host vehicle and the second route is associated with a lane change.

13. The method of claim 11, wherein the generating of the first route and the second route comprises:
generating a potential field by:
determining, based on a driving direction of the host vehicle based on the shape of the road, a first potential of the potential field; and
determining, based on a location of the target vehicle, a second potential of the potential field.

14. The method of claim 13, wherein the generating of the first route and the second route comprises:
generating the first route and the second route based on a sum potential of the first potential and the second potential in the potential field.

15. The method of claim 11, wherein the determining of the probability score of the successful lane change comprises:
determining the probability score of the successful lane change further based on a location of the host vehicle, a speed of the host vehicle, a location of the target vehicle, and a speed of the target vehicle.

16. The method of claim 15, wherein the target vehicle is a first target vehicle, and
wherein the determining of the probability score of the successful lane change comprises:
based on the location of the host vehicle, the speed of the host vehicle, the location of the target vehicle, and the speed of the target vehicle, determining:
a probability score of a second target vehicle decelerating, wherein the second target vehicle is traveling in an adjacent driving lane of the target vehicle; and
a probability score of a collision-free lane change of the first target vehicle; and
determining the probability score of the successful lane change of the host vehicle further based on the probability score of the second target vehicle decelerating and the probability score of the collision-free lane change of the first target vehicle.

17. The method of claim 16, wherein the determining of the probability score of the second target vehicle decelerating comprises:
determining, based on an expected time to collision between the host vehicle and the first target vehicle, the probability score of the second target vehicle decelerating.

18. The method of claim 16, wherein the determining of the probability score of the collision-free lane change of the first target vehicle comprises:
determining, based on a relative distance between the host vehicle and the first target vehicle, the probability score of the collision-free lane change of the first target vehicle.

19. The method of claim 11, wherein the generating of the vehicle control signal comprises:
using the probability score of the successful lane change as a weight.

20. The method of claim 19, wherein the generating of the vehicle control signal comprises:
applying the probability score of the successful lane change as the weight to each control point of the first route and the second route.
